(19) United States
(12) Patent Application Publication
(10) Pub. No.: US 2014/0099040 A1
(43) Pub. Date: Apr. 10, 2014

(54) IMAGE PROCESSING DEVICE AND IMAGE PROCESSING METHOD

(71) Applicant: SONY CORPORATION, Tokyo (JP)

(72) Inventors: Hirotoshi MAEGAWA, Tokyo (JP); Kazuhito IKEMOTO, Kanagawa (JP); Hideki MATSUMOTO, Tokyo (JP)

(73) Assignee: SONY CORPORATION, Tokyo (JP)

(21) Appl. No.: 14/010,967

(22) Filed: Aug. 27, 2013

(30) Foreign Application Priority Data
Oct. 5, 2012 (JP) 2012223046

(51) Int. Cl. G06T 9/00

(52) U.S. Cl. CPC G06T 9/00
USPC 382/232

(57) ABSTRACT

There is provided an image processing device including a renderer configured to generate a frame image in real time, an encoder configured to encode the frame image to generate an encoded data, a sender configured to transmit the encoded data to a client device over a network, the client device being configured to decode the encoded data and output the frame image, and a controller configured to predict an increase of delay incurred in receiving the encoded data in the client device and control a generation interval of the frame image by the renderer based on the prediction.

### BACKGROUND

The present disclosure relates to an image processing device and an image processing method.

In a streaming system in which video or audio is distributed from a server to a client over a network, for example, there is the variation (jitter) of data transfer rate due to change in a communication state of the network. When the communication state where a data transfer rate is lower than a value in the design continues, there is a possibility of occurrence of frame loss. That is, the frame loss means that a frame image, which would have been displayed in a normal condition, is not displayed on a client due to the delay of data transfer.

In order to prevent the occurrence of frame loss, for example, techniques as disclosed in Japanese Unexamined Patent Application Publication No. 2011-119971 and Japanese Unexamined Patent Application Publication No. 2002-084339 have been proposed. In these techniques, the data transfer rate of a server is changed depending on a buffer state of data of a frame image in a client. When data of a frame image being buffered in a client is reduced, it is possible to prevent the occurrence of frame loss by lowering a transfer rate of data, but it leads to degradation of the image quality.

### SUMMARY

However, for a streaming system in which a frame image generated in real time in a server is encoded sequentially and then is transmitted to a client, it is difficult to employ a method of lowering the transfer rate of data, for example, by thinning out frames to be transmitted, because a series of frame images are not provided previously. In addition, when it is important to achieve a real-time property, frame images to be buffered in a client become smaller. Thus, it is not easy to take any actions according to a buffer state as described above.

Therefore, in accordance with an embodiment of the present disclosure, there is provided, in a streaming system in which a frame image is generated in real time, a novel and improved image processing device and image processing method that capable of outputting a frame image more smoothly by allowing a server side to predict a delay in receiving a frame image in a client.

According to an embodiment of the present disclosure, there is provided an image processing device including a renderer configured to generate a frame image in real time, an encoder configured to encode the frame image to generate an encoded data, a sender configured to transmit the encoded data to a client device over a network, the client device being configured to decode the encoded data and output the frame image, and a controller configured to predict an increase of delay incurred in receiving the encoded data in the client device and control a generation interval of the frame image by the renderer based on the prediction.

According to an embodiment of the present disclosure, there is provided an image processing method including generating a frame image in real time, encoding the frame image to generate an encoded data, transmitting the encoded data to a client device over a network, the client device being configured to decode the encoded data and output the frame image, and predicting an increase of delay incurred in receiving the encoded data in the client device and controlling a generation interval of the frame image based on the prediction.

It is capable of previously preventing a possible delay in receiving and of outputting a frame image more smoothly in a client by allowing a server side to predict a delay in receiving a frame image in a client and by controlling a generation interval of a frame image based on the prediction.

In accordance with embodiments of the present disclosure, in a streaming system in which a frame image is generated in real time, it is capable of outputting a frame image more smoothly by allowing a server side to predict a delay in receiving a frame image in a client.

### BRIEF DESCRIPTION OF THE DRAWINGS

FIG. 1 is a schematic diagram illustrating an overall configuration of a streaming system in accordance with an embodiment of the present disclosure;

FIG. 2 is a diagram illustrating an example of an information flow in the streaming system in accordance with an embodiment of the present disclosure;

FIG. 3 is a schematic diagram illustrating a functional configuration of a client and server in the streaming system in accordance with an embodiment of the present disclosure;

FIG. 4 is a schematic diagram illustrating a functional configuration of a streaming processing unit in accordance with an embodiment of the present disclosure;

FIG. 5 is a diagram for explaining a first embodiment of the present disclosure;

FIG. 6 is a diagram for explaining a second embodiment of the present disclosure; and

FIG. 7 is a block diagram for explaining a hardware configuration of an information processing apparatus.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Configuration of Streaming System
1-1. Overall Configuration
1-2. Client and Server Configurations
1-3. Streaming Processing Unit Configuration

2. Configuration for controlling Image Generation Rate
2-1. First Embodiment
2-2. Second Embodiment

3. Hardware Configuration

4. Supplement

### 1. Streaming System Configuration

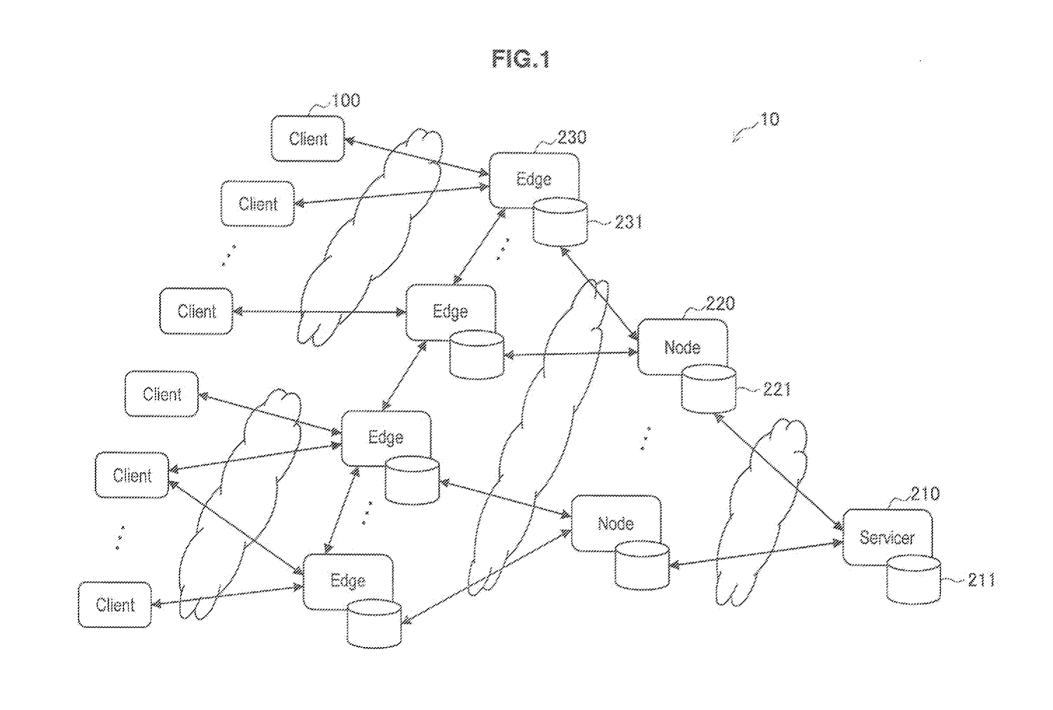

The configuration of a streaming system to which an embodiment of the present disclosure is applied will be described with reference to FIGS. 1 to 4.

### 1-1. Overall Configuration

FIG. 1 is a schematic diagram illustrating an overall configuration of a streaming system with accordance with an embodiment of the present disclosure. Referring to FIG. 1, a streaming system 10 includes a client 100 and a server (servicer 210, node 220, and edge 230) which is configured to distribute streaming contents to the client 100. The client 100 and each server are connected to each other through various types of wired or wireless networks.

The servicer 210 holds original content 211. The node 220 is the node that constitutes a content delivery network (CDN) and holds content 221 obtained by copying the original content held by the servicer 210. The edge 230 performs a direct interaction with the client 110 and appropriately processes the content on request, and provides the processed content to the client 100. In this case, the edge 230 obtains the content held by the node 220 as a cache 231 and provides the content to the client 100 on request from the client 100.

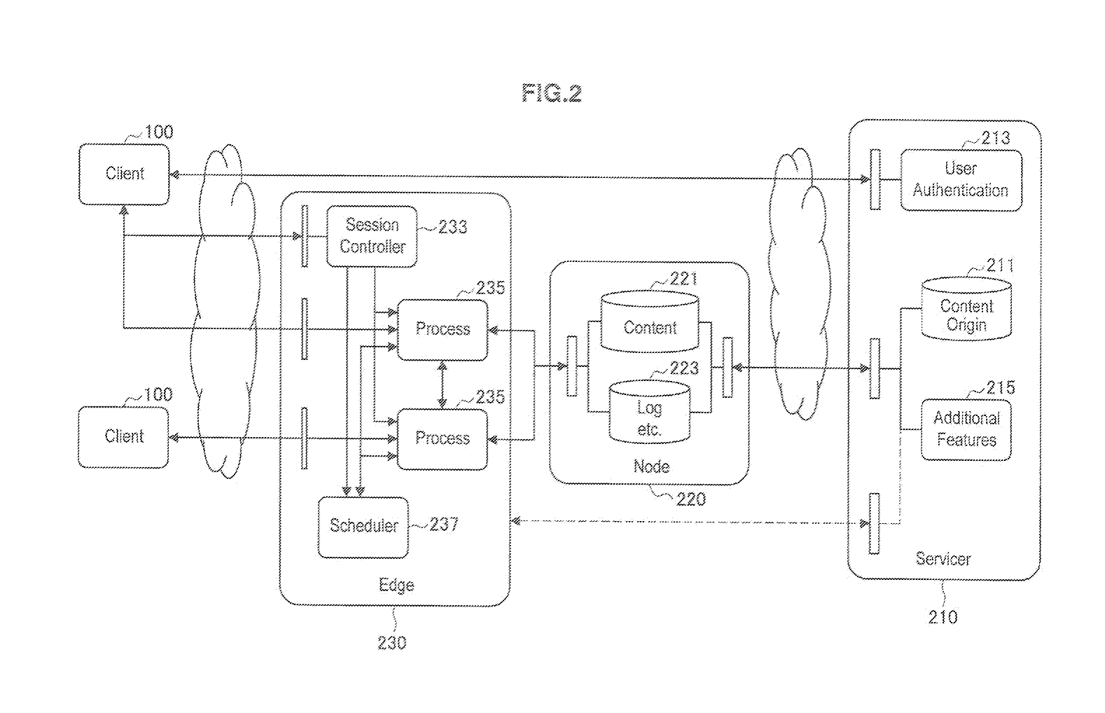

FIG. 2 is a diagram illustrating an example of an information flow in the streaming system in accordance with an embodiment of the present disclosure. The client 100 accesses a user authentication module 213 of the servicer 210 to log into a service prior to distribution of content. When the client 100 is successfully logged into the service, the client 100 accesses a session controller 233 of the edge 230 and requests the session controller 233 to start a process for the client 100. In response to this request, the session controller 233 starts up a process 235.

The edge 230 allows the process 235 to be started up for each client 100 and executes a process for distributing content in response to a request from each client 100. Thus, when the edge 230 provides a service to a plurality of clients 100, a plurality of processes 235 may be started up in the edge 230. Each of the processes 235 is scheduled by a scheduler 237. The scheduler 237 is controlled by the session controller 233.

On the other hand, the original content 211 held by the servicer 210 is previously copied by the node 220 and is held in the node 220 as the content 221. In the process 235 that is activated in the edge 230, the content 221 held in node 220 is obtained as a cache in response to the request from the client 100, the content 221 is appropriately processed, and the processed content is provided to the client 100. In this case, a log of how the content is provided in response to what kind of requests from a client 100 may be recorded in the process 235. This log and other information may be provided to the node 220 by the process 235 and may be held as information 223 in the node 220. The information 223 that contains the log, etc. may be used, for example, by additional features of the servicer 210.

### 1-2. Client and Server Configurations

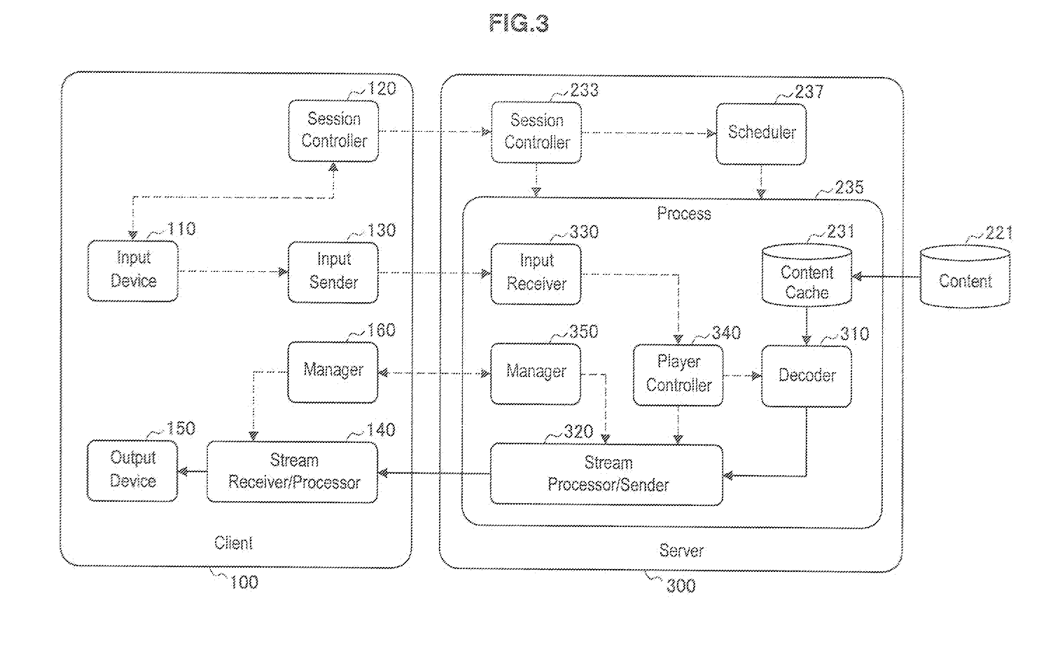

FIG. 3 is a schematic diagram illustrating a functional configuration of the client and server in the streaming system in accordance with an embodiment of the present disclosure. A server 300 functions as the edge 230 in the streaming system described above with reference to FIGS. 1 and 2. In FIG. 3, a solid line indicates the flow of streaming content to be distributed to a client 100, and a broken line indicates the flow of control information related to the reproduction of the streaming content.

The client 100 is the device that provides streaming content to a user, and may be various types of personal computers, tablet terminals, mobile phones (including smart phones), media players, game consoles, or the like. On the other hand, the server 300 may be a single server device, or may be a collection of functions that are implemented by cooperation of a plurality of server devices connected to each other through various wired or wireless networks. The client 100 and each server device constituting the server 300 may be implemented, for example, using the hardware configuration of an information processing apparatus to be described later. The components, except for a device such as an input and output device, and data (stored in a storage device) among the structural elements illustrated in FIG. 3, may be implemented in software by a processor such as a central processing unit (CPU).

In the client 100, an input device 110 obtains a user's operation input. The input device 110 obtains an operation input related to the outside of content such as login to a service or selection of content and an operation input related to the inside of content such as still/moving image switching, image zoom in/out, or sound quality switching of audio. The operation input related to the outside of content is processed by a session controller 120. The session controller 120 may send input information related to the login to the servicer 210 and may send a request to start a process to the server 300 after login. On the other hand, the operation input related to the inside of content is sent from an input sender 130 to the server 300.

In the server 300, in response to the request to start a process from the client 100, the session controller 233 starts up the process 235. The process 235 obtains the content 221 that is specified by a content selection operation obtained by the input device 110 of the client 100 and holds the obtained content as a content cache 231. The content cache 231 is the encoded data and is decoded by a decoder 310 in the server 300. The decoded content data is processed in a stream processor/sender 320.

On the other hand, an operation input related to the inside of content obtained by the input device 110 of the client 100 is received by an input receiver 330 and is provided to a player controller 340. The player controller 340 controls the decoder 310 or the stream processor/sender 320 in response to the operation input. The stream processor/sender 320 generates video and audio from content data according to the control of the player controller 340. Furthermore, the stream processor/sender 320 encodes the generated video or audio and sends it to the client 100. In the illustrated example, the content includes video and audio, but in other examples, the content may include either one of video and audio.

The encoded data sent to the client 100 is decoded by a stream receiver/processor 140 and is rendered as video or audio, and then is outputted from an output device 150 to a user. The stream processor/sender 320 of the server side is managed by a manager 350, and the stream receiver/processor 140 of the client side is managed by a manager 160. The sever-side manager 350 and the client-side manger 160 cooperate with each other by exchanging information as necessary.

### 1-3. Streaming Processing Unit Configuration

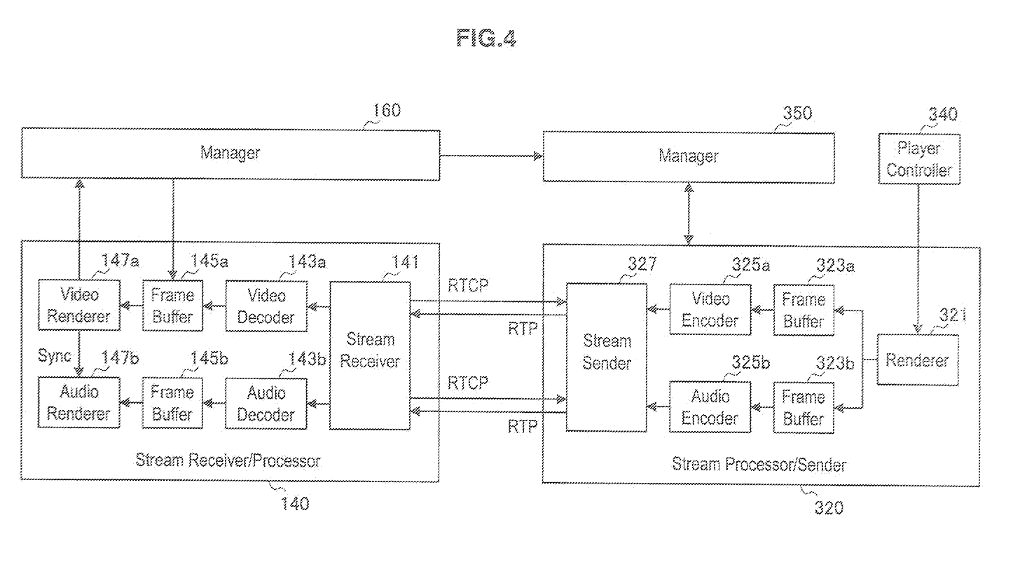

FIG. 4 is a schematic diagram illustrating a functional configuration of a streaming processing unit in accordance with an embodiment of the present disclosure. In FIG. 4, functional configurations of the stream receiver/processor 140 of the client 100 and the stream processor/sender 320 of the server 300 are illustrated.

(Client Side)

The stream receiver/processor 140 includes a stream receiver 141, a decoder 143, a frame buffer 145, and a renderer 147. The stream receiver 141 receives data from a stream sender 327 of the server side according to a predetermined protocol. In the illustrated example, a real-time transport protocol (RTP) is used. In this case, the stream receiver 141 provides the received data to the decoder 143. In addition, the stream receiver 141 detects the communication state such as the delay of data, and reports the detected communication state to the stream sender 327 using an RTP control protocol (RTCP).

The decoder 143 decodes data provided from the stream receiver 141 to obtain video or audio data. The decoder 143 includes a video decoder 143a that decodes video data and an audio decoder 143b that decodes audio data. In the stream receiver/processor 140, there may be provided with a plurality of types of each of the video decoder 143a and the audio decoder 143b, which may be selectively used depending on the format of data to be processed. In the following description, any one or both of the video decoder 143a and the audio decoder 143b may be referred to as simply the decoder 143 (when referring to either one of them, whether data to be processed by the one is video or audio will be specified).

The frame buffer 145 temporarily stores the video and audio data obtained by the decoder 143 on a frame-by-frame basis. The frame buffer 145 includes a frame buffer 145a that stores video data and a frame buffer 145b that stores audio data. The frame buffer 145 provides video or audio data in each frame to the renderer 147 at a predetermined timing under the control of the manager 160. In the following description, any one or both of the frame buffer 145a and the frame buffer 145b may be referred to as simply the frame buffer 145 (when referring to either one of them, whether data to be processed by the one is video or audio will be specified).

The renderer 147 includes a video renderer 147a and an audio renderer 147b. The video renderer 147a renders video data and provides the rendered data to an output device such as a display. The audio renderer 147b renders audio data and provides the rendered data to an output device such as a loudspeaker. The video renderer 147a and the audio renderer 147b respectively synchronize frames of video and audio being outputted. In addition, the renderer 147 reports an ID of the outputted frame, the time when the output is performed, or the like to the manager 160. In the following description, any one or both of the video renderer 147a and the audio renderer 147b may be referred to as simply the renderer 147 (when referring to either one of them, whether data to be processed by the one is video or audio will be specified).

(Server Side)

The stream processor/sender 320 includes a renderer 321, a frame buffer 323, an encoder 325, and a stream sender 327. The renderer 321 uses the content data decoded by the decoder 310 as a source material and generates video data and audio data according to the control by the player controller 340 based on the user's operation input. The frame for video and audio data is defined, and the video data is generated as continuous frame images.

The frame buffer 323 temporarily stores the video and audio data generated by the renderer 321 on a frame-by-frame basis. The frame buffer 323 includes a frame buffer 323a that stores video data and a frame buffer 323b that stores audio data. The video data and audio data stored in the frame buffer 323 are sequentially encoded by the encoder 325. In the following description, any one or both of the frame buffer 323a and the frame buffer 323b may be referred to as simply the frame buffer 323 (when referring to either one of them, whether data to be processed by the one is video or audio will be specified).

The encoder 325 includes a video encoder 325a that encodes video data and an audio encoder 325b that encodes audio data. In the stream processor/sender 320, there may be provided with a plurality of types of each of the video encoder 325a and the audio encoder 325b, which may be selectively used depending on the types of the video decoder 143a and the audio decoder 143b that can be used by the client 100 or the characteristics of the video or audio data to be processed. The video data and audio data encoded by the encoder 325 are sent from the stream sender 327 to the client 100. In the following description, any one or both of the video encoder 325a and the audio encoder 325b may be referred to as simply the encoder 325 (when referring to either one of them, whether data to be processed by the one is video or audio will be specified).

According to the configuration of the streaming system in accordance with the present embodiment as described above, in the server which functions as an edge, it is possible to generate video or audio in real time in response to the user's operation input and distribute it to the client. Thus, it is possible to provide applications by the streaming method while maintaining the responsiveness for user's operation input. Such applications includes an application in which images are freely zoomed in/out or moved as described in, for example, Japanese Unexamined Patent Application Publication No. 2010-117828 or various applications such as browsing of a large-sized image or video, on-line games, simulations.

### 2. Configuration for Controlling Image Generation Rate

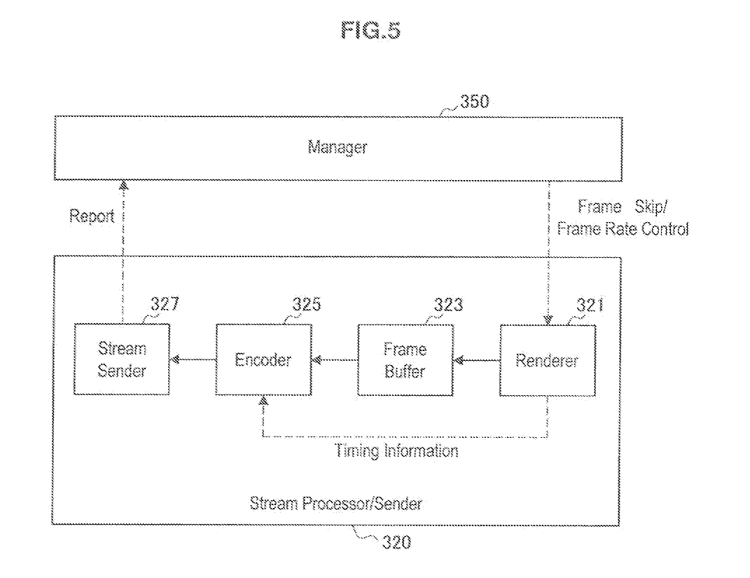

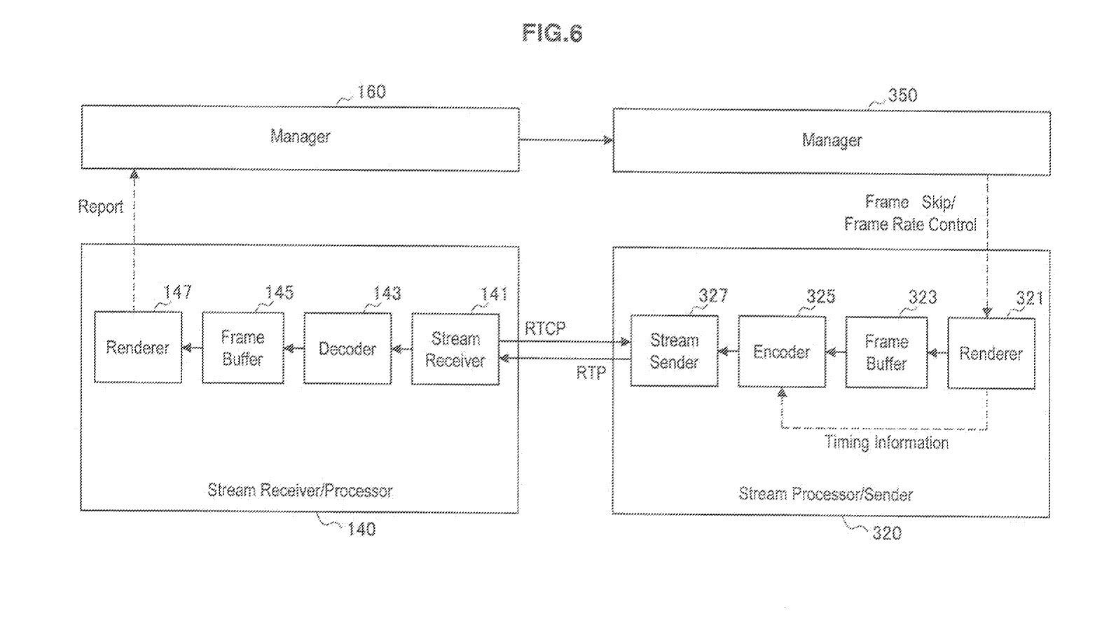

Next, referring to FIGS. 5 and 6, a configuration for controlling an image generation rate in accordance with an embodiment of the present disclosure will be described. The configuration for controlling an image generation rate will now be described by way of first and second embodiments.

### 2-1. First Embodiment

FIG. 5 is a diagram for explaining a first embodiment of the present disclosure. In this first embodiment, an amount of delay incurred in receiving data in a client is predicted based on a state of delay in transmitting data from a server.

In the streaming system 10, the server 300 generates a video in real time according to a user's operation input and distributes it to the client 100. For this reason, contents of each frame image constituting the video may be changed depending on the circumstances. In addition, the time (drawing processing time) taken to perform a process of generating a frame image by the renderer 321 or the time (encoding processing time) taken to encode a frame image by the encoder 325 is likely to be irregularly varied.

The encoded data of a frame image in which any one or both of the drawing processing time and encoding processing time are longer than an assumed value is transmitted from the stream sender 327 toward the client 100 with a delay as compared to an expected timing. In this case, the timing when the stream receiver 141 of the client 100 receives the encoded data is similarly delayed, and additionally, when there is a significant delay in a network, the timing will be delayed more than that.

When this delay exceeds a range that can be absorbed by the frame buffer 145, there occurs any frame loss in a video outputted from the client 100. Such frame loss may occur due to, for example, the fact that the processing time of a frame image is longer unexpectedly, and additionally, such frame loss may occur due to the fact that frame images in which the processing time is just slightly greater than an assumed value are continued and then the delay is accumulated.

Therefore, in the present embodiment, the stream sender 327 reports the timing of transmitting the encoded data toward the client 100 to the manager 350. The manager 350 predicts an amount of delay to be incurred in receiving data in the client 100 based on a delay state of the transmitting timing. If there is a possibility that a frame loss occurs on the ground of the predicted amount of delay, the manager 350 controls the renderer 321 to extend the generation interval of a frame image.

In the following, there will be given a description of how the manager 350 predicts the amount of delay to be incurred in receiving data in the client 100 and a description regarding what kind of control is performed by the renderer 321 to cause the generation interval of a frame image to be extended.

(Prediction of Amount of Delay in Receiving Data)

As described above, the reception of encoded data in the client 100 is delayed by at least as much as an amount of delay in transmitting data from the stream sender 327, and when there is a significant delay in a network, the reception will be delayed more than that. Thus, in the present embodiment, the manager 350 estimates the amount of delay from a predetermined timing of the transmitting timing of encoded data by the stream sender 327 to be a minimum value of an amount of delay incurred in receiving data in the client 100. The manager 350 can predict the amount of delay to be incurred in receiving data by adding an increased or decreased amount of the assumed amount of delay in a network to the minimum value.

There are some examples of defining the amount of delay from a predetermined timing of the transmitting timing of encoded data by the stream sender 327.

A first example employs the difference between an interval of the transmitting timing of data and a predetermined interval. The interval of the transmitting timing of data by the stream sender 327 is coincident with a predetermined interval defined by a frame rate of video (for example, if a frame rate is 30 fps (frames per second), the interval is 33.3 msec) in a normal condition. Thus, when the interval of the transmitting timing of data is longer than a predetermined interval, it is estimated that the transmitting timing of data is delayed by virtue of the fact that data is not a state which can be transmitted until the predetermined timing is reached.

A second example employs the difference between a processing time for each frame image and a predetermined time. The time from when the renderer 321 starts to generate a frame image to when the encoder 325 encodes the generated image and the stream sender 327 transmits the outputted encoded data is substantially constant for each frame in a normal condition. Thus, if the processing time from when the renderer 321 starts to create a frame image to when the stream sender 327 transmits the encoded data is longer than an average processing time or a processing time on design, then it is estimated that the transmitting timing of data is delayed by virtue of the fact that a process on the renderer 321 or the encoder 325 is not completed until a predetermined timing is reached.

Whether or not it is necessary to extend the generation interval of a frame image for the increased amount of delay in receiving data which is predicted as described above may be determined depending on whether the increased amount of delay exceeds a predetermined threshold that is set according to a buffer size of the frame image in the client 100.

(Extension of Generation Interval of Frame Image)

As described above, if the transmission of encoded data from the stream sender 327 of the server 300 is delayed, then the reception of data in the client 100 is delayed not less than that amount. Thus, if the delay in transmitting data from the stream sender 327 is reduced, then the delay in receiving data in the client 100 is also more likely to be reduced. Therefore, if the predicted amount of delay in receiving data is large, then the manager 350 reduces the delay in transmitting data from the stream sender 327 by controlling the renderer 321 to extend the generation interval of a frame image.

When the control for extending the generation interval of a frame image is performed by the manager 350, as described below, the renderer 321 extends the generation interval of a frame image by skipping the generation of a frame image or reducing the generation rate of a frame image. In this case, the frame image may not be generated primarily at the timing when the frame image would have been generated, and thus the renderer 321 (i) notifies the change in the generation timing of a frame image to the encoder 325 as shown in FIG. 5, or (ii) provides an alternative frame image to the encoder 325.

The processing amount per time in the renderer 321 is reduced by extending the generation interval of a frame image. This allows the delay in transmitting data incurred by performing a process in the renderer 321 to be eliminated. In addition, in the case of the above (i), the interval between processes in the encoder 325 is extended and the processing amount per time is reduced. In the case of the above (ii), the interval between processes in the encoder 325 is not changed, but the processing amount of the renderer 321 is reduced, thereby increasing a resource amount of a CPU or the like available by the encoder 325. Thus, in both cases, the delay in transmitting data incurred by performing a process in the encoder 325 is eliminated.

There are some examples of a specific process executed by the renderer 321 that have taken over a control to extend the generation interval of a frame image.

As a first example, the renderer 321 may skip a process of generating one or a plurality of frame images to extend the generation interval of the frame image. In this case, the renderer 321 provides a copy of a frame image generated immediately before skipping to the encoder 325 instead of the frame image in which its generation process is skipped, and the encoder 325 may continue to perform a process in a similar way to a case where the generation process is not skipped. Alternatively, the renderer 321 may notify the timing at which the generation of a frame image is skipped to the encoder 325, and the encoder 325 may output a copy of the encoded data of the frame image outputted immediately before at the timing.

As a second example, the renderer 321 may decrease the generation rate of a frame image to extend the generation interval of a frame image. In this case, when a frame image is not generated due to decrease in the generation rate at a timing when the frame image is to be generated, the renderer 321 may provide a frame image generated immediately before it to the encoder 325, and the renderer 321 may continue to perform a process in a similar way to a case where the generation rate is not decreased. Alternatively, the renderer 321 may notify the changed generation rate to the encoder 325, and the encoder 325 may encode the frame image at the same rate as the changed rate. In this case, if a frame image is not generated at a timing at which the frame image is to be generated, then the encoder 325 outputs the encoded data of the frame image outputted immediately before.

The generation interval of a frame image that is extended as described above may be continued, for example, for a predetermined duration or predetermined number of frames. In the case of the first example, during a predetermined duration or predetermined number of frames, a frame image may be generated by skipping a predetermined number of frames (for example, every other, every third, etc.). In addition, in the case of the second example, during a predetermined duration or predetermined number of frames, setting of the decreased generation rate is maintained.

Alternatively, the manager 350 may monitor the processing amounts of the renderer 321 and the encoder 325 before and after extending the generation interval of a frame image, and may restore the generation interval to its original condition if the processing amount is sufficiently lowered. The sufficiently lowered processing amount means that, for example, when the generation interval of a frame image is extended to two times, the processing amount is less than the half of that before extending. In this case, even if the generation interval of a frame image is restored to its original condition, it is considered that the data transmission is less likely to be delayed.

Even when the generation interval of a frame image is extended using the process as described above, an update interval of image in a video outputted in the client 100 becomes longer than its original condition, that is, this is the same with the case of frame loss. However, if the update interval of a frame image is extended regularly by the control as described above rather than irregular occurrence of frame loss, it is possible to minimize discomfort to the user who is observing the image and allow the output of a frame image to be smoother.

### 2-2. Second Embodiment

FIG. 6 is a diagram for explaining a second embodiment of the present disclosure. In this embodiment, the amount of delay incurred in receiving subsequent data in the client is predicted based on the output state of a previous frame image in the client.

In the streaming system 10, the server 300 generates a video in real time in response to a user's operation input and distributes it to the client 100. In order to implement a high real-time property in the video being displayed, the time difference from when a frame image is generated in the server 300 to when it is outputted in the client 100 is preferably set to be as small as possible. In that reason, if the number of frame images being buffered in the frame buffer 145 of the client 100 is small and the timing at which the stream receiver 141 receives data is delayed than its original timing, frame loss is more likely to be occurred.

Therefore, in the present embodiment, the renderer 147 of the client 100 reports the output state of a frame image to the manager 160 of the client 100. The contents of the report are appropriately determined depending on a prediction method to be performed by the manager 350 of the server 300, which will be described later. The output timing of each frame image may be reported, and when frame loss occurs, a notice to that effect may be reported.

The manager 160 provides information to the manager 350 of the server 300. The manager 160 predicts an amount of delay to be incurred in receiving subsequent data in the client based on the reported output state. If there is a possibility that frame loss occurs based on the predicted amount of delay, the manager 350 controls the renderer 321 to extend the generation interval of a frame image.

In the following, there will be given a description of how the manager 350 predicts an amount of delay to be incurred in receiving data in the client 100. A description regarding what kind of control is performed by the renderer 321 to cause the generation interval of a frame image to be extended is similar to the first embodiment described above, thus repeated explanation thereof is omitted.

(Prediction of Amount of Delay in Receiving Data)

In the present embodiment, an amount of delay in receiving subsequent data in the client 100 is predicted based on the output state of a frame image provided from the client 100. Thus, this prediction reflects a network delay in addition to the delay incurred in the server 300 as described in the first embodiment. Accordingly, unlike the first embodiment, an amount of delay to be predicted may not be necessarily represented by a numeral value. For example, when frame loss occurs, a report to that effect is issued by the renderer 147 of the client 100. In this case, the manger 350 of the server 300 can predict. “An amount of delay in receiving subsequent data may cause occurrence of frame loss” based on the report, and the manger 350 can control the renderer 321 to extend the generation interval of a frame image.

In this regard, the manager 350 may perform the control of the renderer 321 by a one-time report of frame loss. In addition, the manager 350 may perform the control of the renderer 321 by a predetermined number of times of reports of frame loss that are obtained within a predetermined period of time. In this case, the predetermined number of times may be two or more. Alternatively, when the rate of a frame images which have not been outputted due to frame loss to the frame images which are to be outputted within a predetermined period of time exceeds a predetermined value, the manager 350 may perform the control of the renderer 321.

The manager 350 may predict an amount of delay in receiving subsequent data using a numerical value. For example, when the renderer 147 reports an output timing for each frame image, the manager 350 (or manager 160) may estimate an amount of delay from a predetermined timing of the output timing as the amount of delay incurred in receiving subsequent data in the client 100.

As with the example of the transmitting timing, also with respect to the output timing, there are some examples of defining an amount of delay from a predetermined timing.

A first example employs the difference between an interval of the output timing of a frame image and a predetermined interval. The interval of the timing of outputting a frame image by the renderer 147 is coincident with a predetermined interval defined by a frame rate of video (for example, if a frame rate is 30 fps, the interval is about 33.3 msec) in a normal condition. Thus, when the interval of the output timing of a frame image is longer than a predetermined interval, it is estimated that data is not received at the predetermined timing and thus is delayed.

A second example employs the difference between a processing/transmission time for each frame image and a predetermined time. The time from when the renderer 321 starts to generate a frame image (or from when the stream sender 327 transmits encoded data) to when a frame image is outputted in the client 100 is substantially constant for each frame in a normal condition. Thus, if a processing/transmission time from when the renderer 321 starts to create a frame image (or from when the stream sender 327 transmits the encoded data) to when the frame image is outputted in the client 100 is longer than an average processing/transmission time or a processing/transmission time on design, then it is estimated that data is not received at the predetermined timing and thus is delayed by virtue of the fact that there is a delay in processing a frame image in the server 300 or a delay in transmitting data in a network.

Whether or not it is necessary to extend the generation interval of a frame image for the increased amount of delay in receiving data which is predicted as described above may be determined, for example, depending on whether the increased amount of delay exceeds a predetermined threshold that is set according to a buffer size or the like of the frame image in the client 100.

(Control of Image Generation Interval)

As described above, in the present embodiment, as with the above first embodiment, the manger 350 of the server 300 controls the renderer 321 to extend the generation interval of a frame image. In addition, in the present embodiment, the predicted amount of delay in receiving data reflects the network delay, and thus additional configuration as described below may be employed.

In the first embodiment described above, even when the generation interval of a frame image is extended in the renderer 321, the use of a frame image generated immediately before the extension or the encoded data of the frame image allows the interval over which the encoder 325 outputs the encoded data to be maintained. On the other hand, in the present embodiment, the extension of the generation interval of a frame image is notified to the stream receiver/processor 140 of the client 100 as well as the stream sender 327, and thus the interval over which the encoded data is transmitted from the server 300 to the client 100 may be extended. Consequently, since the amount of data transmitted from the server 300 to the client 100 over a network can be reduced, even when the network delay is large, it is possible to prevent the occurrence of frame loss effectively.

### 3. Hardware Configuration

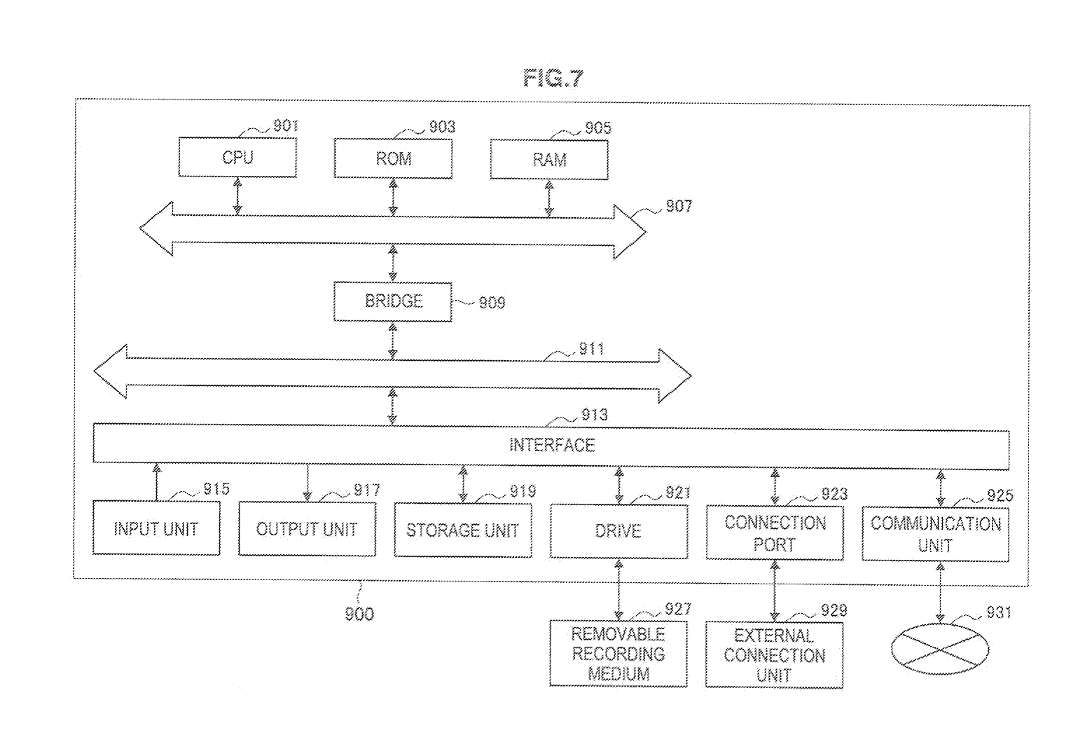

A hardware configuration of the information processing apparatus according to an embodiment of the present disclosure will be described with reference to FIG. 7. FIG. 7 is a block diagram for explaining a hardware configuration of the information processing apparatus. The illustrated information processing apparatus 900 may be implemented, for example, as the client 100 and the server 300 in the embodiments described above.

The information processing apparatus 900 includes a CPU (Central Processing Unit) 901, a ROM (Read Only Memory) 903, and a RAM (Random Access Memory) 905. In addition, the information processing apparatus 900 may include a host bus 907, a bridge 909, an external bus 911, an interface 913, an input unit 915, an output unit 917, a storage unit 919, a drive 921, a connection port 923, and a communication unit 925. The information processing apparatus 900 may include a processing circuit such as a DSP (Digital Signal Processor), alternatively or in addition to the CPU 901.

The CPU 901 serves as an operation processor and a controller, and controls all or some operations in the information processing apparatus 900 in accordance with various programs recorded in the ROM 903, the RAM 905, the storage unit 919 or a removable recording medium 927. The ROM 903 stores programs and operation parameters which are used by the CPU 901. The RAM 905 primarily stores program which are used in the execution of the CPU 901 and parameters which is appropriately modified in the execution. The CPU 901, ROM 903, and RAM 905 are connected to each other by the host bus 907 configured to include an internal bus such as a CPU bus. In addition, the host bus 907 is connected to the external bus 911 such as a PCI (Peripheral Component Interconnect/Interface) bus via the bridge 909.

The input unit 915 may be a device which is operated by a user, such as a mouse, a keyboard, a touch panel, buttons, switches and a lever. The input unit 915 may be, for example, a remote control unit using infrared light or other radio waves, or may be an external connection unit 929 such as a portable phone operable in response to the operation of the information processing apparatus 900. Furthermore, the input unit 915 includes an input control circuit which generates an input signal on the basis of the information which is input by a user and outputs the input signal to the CPU 901. By operating the input unit 915, a user can input various types of data to the information processing apparatus 900 or issue instructions for causing the information processing apparatus 900 to perform a processing operation.

The output unit 917 includes a device capable of visually or audibly notifying the user of acquired information. The output unit 917 may include a display device such as LCD (Liquid Crystal Display), PDP (Plasma Display Panel), and organic EL (Electro-Luminescence) displays, an audio output device such as speaker and headphone, and a peripheral device such as printer. The output unit 917 may output the results obtained from the process of the information processing apparatus 900 in a form of a video such as text or image, and an audio such as voice or sound.

The storage unit 919 is a device for data storage which is configured as an example of a storage unit of the information processing apparatus 900. The storage unit 919 includes, for example, a magnetic storage device such as HDD (Hard Disk Drive), a semiconductor storage device, an optical storage device, or a magneto-optical storage device. The storage unit 919 stores programs to be executed by the CPU 901, various data, and data obtained from the outside.

The drive 921 is a reader/writer for the removable recording medium 927 such as a magnetic disk, an optical disk, a magneto-optical disk, or a semiconductor memory, and is embedded in the information processing apparatus 900 or attached externally thereto. The drive 921 reads information recorded in the removable recording medium 927 attached thereto, and outputs the read information to the RAM 905. Further, the drive 921 can write in the removable recording medium 927 attached thereto.

The connection port 923 is a port used to directly connect devices to the information processing apparatus 900. The connection port 923 may include a USB (Universal Serial Bus) port, an IEEE1394 port, and a SCSI (Small Computer System Interface) port. The connection port 923 may further include an RS-232C port, an optical audio terminal, an HDMI (High-Definition Multimedia Interface) port, and so on. The connection of the external connection unit 929 to the connection port 923 makes it possible to exchange various data between the information processing apparatus 900 and the external connection unit 929.

The communication unit 925 is, for example, a communication interface including a communication device or the like for connection to a communication network 931. The communication unit 925 may be, for example, a communication card for a wired or wireless LAN (Local Area Network), Bluetooth (registered trademark), WUSB (Wireless USB) or the like. In addition, the communication unit 925 may be a router for optical communication, a router for ADSL (Asymmetric Digital Subscriber Line), a modem for various kinds of communications, or the like. The communication unit 925 can transmit and receive signals to and from, for example, the Internet or other communication devices based on a predetermined protocol such as TCP/IP. In addition, the communication network 931 connected to the communication unit 925 may be a network or the like connected in a wired or wireless manner, and may be, for example, the Internet, a home LAN, infrared communication, radio wave communication, satellite communication, or the like.

As above, the exemplary hardware configuration of the information processing apparatus 900 has been described. Each of the above-described constituent elements may be configured using general-purpose members, or may be configured by hardware specialized to the function of each constituent element. Therefore, a hardware configuration to be used may be appropriately modified according to the technical level at the time of implementing the embodiment.

### 4. Supplement

Embodiments of the present disclosure may include the image processing device described above (for example, it is included in a server), a system, a method executed in the image processing device or the system, a program for causing the image processing device to function, and a recording medium with the program recorded thereon.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An image processing device including:

a renderer configured to generate a frame image in real time;

an encoder configured to encode the frame image to generate an encoded data;

a sender configured to transmit the encoded data to a client device over a network, the client device being configured to decode the encoded data and output the frame image; and

a controller configured to predict an amount of delay incurred in receiving the encoded data in the client device and control a generation interval of the frame image by the renderer based on the amount of delay.

(2) The image processing device according to (1), wherein

the controller predicts the amount of delay based on an amount of delay of a transmission timing of the encoded data in the sender.

(3) The image processing device according to (2), wherein the controller calculates the amount of delay of the transmission timing based on a difference between an interval of the transmission timing and a predetermined value.
(4) The image processing device according to (2), wherein the controller calculates the amount of delay of the transmission timing based on a difference between a time from a timing when the renderer starts to generate the frame image to the transmission timing and a predetermined value.
(5) The image processing device according to (1), wherein

the controller predicts the amount of delay based on an output state of the frame image in the client device, the output state being reported from the client device.

(6) The image processing device according to (5), wherein

the controller predicts that the amount of delay is an amount to such an extent as to be necessary to control the generation interval when a loss is incurred for one or a plurality of the frame images in the client device.

(7) The image processing device according to (6), wherein

the controller predicts that the amount of delay is an amount to such an extent as to be necessary to control the generation interval when a ratio of a lost image out of the frame images exceeds a predetermined value.

(8) The image processing device according to (5), wherein

the controller predicts the amount of delay based on an amount of delay of an output timing of the frame image.

(9) The image processing device according to (8), wherein the controller calculates the amount of delay of the output timing based on a difference between an interval of the output timing and a predetermined value.
(10) The image processing device according to (8), wherein the controller calculates the amount of delay of the output timing based on a difference between a time from a timing when the renderer starts to generate the frame image to the output timing and a predetermined value.
(11) The image processing device according to (8), wherein the controller calculates the amount of delay of the output timing based on a difference between a time from a transmission timing of the encoded data in the sender to the output timing and a predetermined value.
(12) The image processing device according to any one of (1) to (11), wherein

the controller controls the renderer to extend the generation interval based on the amount of delay.

(13) The image processing device according to (12), wherein

the controller controls the renderer to provide, instead of a frame image that is not generated due to the extension of the generation interval, a copy of a frame image generated immediately before the frame image to the encoder.

(14) The image processing device according to (12), wherein

the controller controls the encoder to provide, instead of an encoded data of a frame image that is not generated due to the extension of the generation interval, a copy of an encoded data of a frame image generated immediately before the frame image to the sender.

(15) The image processing device according to any one of (12) to (14), wherein

the controller controls the sender to extend a transmission interval of the encoded data in accordance with the extension of the generation interval.

(16) The image processing device according to any one of (12) to (15), wherein

the controller controls the renderer to extend the generation interval by skipping a generation of one or a plurality of the frame images.

(17) The image processing device according to any one of (12) to (15), wherein

the controller controls the renderer to extend the generation interval by changing a generation rate of the frame image.

(18) The image processing device according to any one of (12) to (17), wherein the controller controls the renderer to extend the generation interval over a predetermined duration or a predetermined number of frames.
(19) The image processing device according to any one of (1) to (18), further including:

a receiver configured to receive an operation input obtained in the client device over the network,

(20) An image processing method including:

generating a frame image in real time;

encoding the frame image to generate an encoded data;

transmitting the encoded data to a client device over a network, the client device being configured to decode the encoded data and output the frame image; and

predicting an amount of delay incurred in receiving the encoded data in the client device and controlling a generation interval of the frame image based on the amount of delay.

The present disclosure contains subject matter related to that disclosed in Japanese Priority Patent Application JP 2012-223046 filed in the Japan Patent Office on Oct. 5, 2012, the entire content of which is hereby incorporated by reference.

What is claimed is:

1. An image processing device comprising:
a renderer configured to generate a frame image in real time;
an encoder configured to encode the frame image to generate an encoded data;
a sender configured to transmit the encoded data to a client device over a network, the client device being configured to decode the encoded data and output the frame image; and
a controller configured to predict an increase of delay incurred in receiving the encoded data in the client device and control a generation interval of the frame image by the renderer based on the prediction.

2. The image processing device according to claim 1, wherein the controller predicts the increase of delay incurred in receiving the encoded data based on an amount of delay of a transmission timing of the encoded data in the sender.

3. The image processing device according to claim 2, wherein the controller calculates the amount of delay of the transmission timing based on a difference between an interval of the transmission timing and a predetermined value.

4. The image processing device according to claim 2, wherein the controller calculates the amount of delay of the transmission timing based on a difference between a time from a timing when the renderer starts to generate the frame image to the transmission timing and a predetermined value.

5. The image processing device according to claim 2, wherein the controller returns the control of the generation interval to an original condition when a processing amount of the renderer and the encoder is equal to or smaller than a predetermined value after the control of the generation interval.

6. The image processing device according to claim 1, wherein the controller predicts the increase of delay incurred in receiving the encoded data based on an output state of the frame image in the client device, the output state being reported from the client device.

7. The image processing device according to claim 6, wherein the controller predicts that there is an increase of delay to such an extent as to be necessary to control the generation interval in receiving the encoded data when a loss is incurred for one or a plurality of the frame images in the client device.

8. The image processing device according to claim 7, wherein the controller predicts that there is an increase of delay to such an extent as to be necessary to control the generation interval in receiving the encoded data when a ratio of a lost image out of the frame images exceeds a predetermined value.

9. The image processing device according to claim 6, wherein the controller predicts an increase of delay incurred in receiving the encoded data based on an amount of delay of an output timing of the frame image.

10. The image processing device according to claim 9, wherein the controller calculates the amount of delay of the output timing based on a difference between an interval of the output timing and a predetermined value.

11. The image processing device according to claim 9, wherein the controller calculates the amount of delay of the output timing based on a difference between a time from a timing when the renderer starts to generate the frame image to the output timing and a predetermined value.

12. The image processing device according to claim 9, wherein the controller calculates the amount of delay of the output timing based on a difference between a time from a transmission timing of the encoded data in the sender to the output timing and a predetermined value.

13. The image processing device according to claim 1, wherein the controller controls the renderer to extend the generation interval based on the prediction.

14. The image processing device according to claim 13, wherein the controller controls the renderer to provide, instead of a frame image that is not generated due to the extension of the generation interval, a frame image generated immediately before the frame image to the encoder.

15. The image processing device according to claim 13, wherein the controller controls the encoder to provide, instead of an encoded data of a frame image that is not generated due to the extension of the generation interval, an encoded data of a frame image generated immediately before the frame image to the sender.

16. The image processing device according to claim 13, wherein the controller controls the sender to extend a transmission interval of the encoded data in accordance with the extension of the generation interval.

17. The image processing device according to claim 13, wherein the controller controls the renderer to extend the generation interval by skipping a generation of one or a plurality of the frame images or changing a generation rate of the frame image.

18. The image processing device according to claim 13, wherein the controller controls the renderer to extend the generation interval over a predetermined duration or a predetermined number of frames.

19. The image processing device according to claim 1, further comprising:
a receiver configured to receive an operation input obtained in the client device over the network,
wherein the renderer generates the frame image in real time in accordance with the operation input.

20. An image processing method comprising:
generating a frame image in real time;
encoding the frame image to generate an encoded data;
transmitting the encoded data to a client device over a network, the client device being configured to decode the encoded data and output the frame image; and
predicting an increase of delay incurred in receiving the encoded data in the client device and controlling a generation interval of the frame image based on the prediction.
